(19) United States
(12) Patent Application Publication
(10) Pub. No.: US 2023/0112146 A1
(43) Pub. Date: Apr. 13, 2023

(54) ROCKER PIN FOR A ROCKER PIN PAIR OF A PLATE LINK CHAIN

(71) Applicant: Schaeffler Technologies AG & Co. KG, Herzogenaurach (DE)

(72) Inventor: Carsten Trautmann, Rastatt (DE)

(73) Assignee: Schaeffler Technologies AG & Co. KG, Herzogenaurach (DE)

(21) Appl. No.: 17/800,228

(22) PCT Filed: Jan. 11, 2021
(86) PCT No.: PCT/DE2021/100010

§ 371 Date: Aug. 17, 2022

(30) Foreign Application Priority Data
Feb. 19, 2020 (DE) 10 2020 104 315.5

(51) Int. Cl. F16G 5/18; F16G 13/08; F16H 9/16

(52) U.S. Cl. CPC F16G 5/18; F16G 13/08; F16H 9/16

(57) ABSTRACT

A plate link chain includes a chain running direction, an axial direction, a radial direction, a plate link, and a rocker pin pair. Each rocker pin has a plate link side contact surface, a rolling surface, and axially opposite end faces. The end faces are inclined axially inwards from radially outside to radially inside, aligned transversely to the axial direction, and arranged for force transmitting contact with a conical pulley pair. The end faces have respective curvatures having a first curvature portion defined by a radial radius about a first axis parallel to the chain running direction, and a second curvature portion defined by an azimuthal radius about a second axis parallel to the radial direction. A magnitude of the radial radius increases from radially outside to radially central, or a magnitude of the azimuthal radius increases from forward to central with respect to the chain running direction.

### CROSS-REFERENCE TO RELATED APPLICATIONS

This application is the United States National Phase of PCT Appln. No. PCT/DE2021/100010 filed Jan. 11, 2021, which claims priority to German Application No. DE102020104315.5 filed Feb. 19, 2020, the entire disclosures of which are incorporated by reference herein.

### TECHNICAL FIELD

The present disclosure relates to a rocker pin for a rocker pin pair of a plate link chain. The present disclosure further relates to a rocker pin pair with such a rocker pin for a plate link chain of a belt transmission, a plate link chain with such a rocker pin pair for a belt transmission of a drive train, a belt transmission with such a plate link chain for a drive train, and a drive train with a such belt transmission.

### BACKGROUND

Rocker pins for a rocker pin pair of a plate link chain are known from the prior art as traction devices in the form of belt elements for belt transmissions; for example, in a so-called CVT (continuous variable transmission). Such a CVT is known, for example, from DE 100 17 005 A1. Such a plate link chain is set up to transmit high torques and high speeds, as is known, for example, from motor vehicle engine construction. Because the gear noises are unfamiliar and generally perceived as annoying, it is a constant challenge to create a plate link chain that has low noise emissions. However, the object is also to provide a long service life of the plate link chain, to avoid the need for replacement over the service life of a motor vehicle, and to provide a high degree of efficiency. Furthermore, small running radii (i.e., diameters effective for the transmission) on the conical pulley pairs of a belt drive desirable so that a large transmission ratio can be achieved in a small (radial) installation space. A plate link chain with rocker pins is known, for example, from WO 2016/095 913 A1.

Noise, vibration and harshness (NVH) and strength are the dominant issues in the further development of the plate link chain. Furthermore, the efficiency and wear must also be improved and, for a large ratio spread and/or small installation space, it must be possible to achieve a small minimum running radius on the conical pulley pairs. So far, attempts have been made to keep the vibration excitation low by using different pitch lengths (implemented by two different plate link types) and their sequence (for example, as chaotic as possible). These measures have already been almost exhausted and further changes promise only little further potential. Another previously known measure is that the angle of the end faces of the rocker pins is made larger than the angle of the conical surface of the conical pulley pairs, so that when entering a conical pulley pair, the radially outer edge of the respective end face of the rocker pin first comes into engagement with the corresponding conical surface of the conical pulley pairs. Only as a result of a deformation of the rocker pin caused by the axial pressing force does a further part, e.g., the entire end face, come into contact with the corresponding surface of the conical pulley pair. However, because this measure leads to edge wear and thus to a higher load on the frictional contact, there are limits to this measure.

### SUMMARY

The present disclosure relates to a rocker pin for a rocker pin pair of a plate link chain having
a length extension which, when in use in a plate link chain, is oriented in the axial direction;
a height extension which, when in use in a plate link chain, is oriented in a radial direction;
a width extension which, when used in a plate link chain, is oriented in the chain running direction;
a plate link-side contact surface for contact with at least one link used in a plate link chain;
a rolling surface for contact with a further rocker pin used in a rocker pin pair; and
axially on both sides, an end face inclined axially inwards from radially outside to radially inside, which is aligned transversely to the longitudinal extension (5) and is arranged for force-transmitting contact with a respective conical surface of a conical pulley pair. The end surface has a curvature, and a first curvature portion is defined by means of a radial radius about a first axis parallel to the chain running direction and a second curvature portion is defined by means of an azimuthal radius about a second axis parallel to the radial direction.

In an example embodiment, the magnitude of the radial radius increases from radially outside to radially central and/or the magnitude of the azimuthal radius increases from forward with respect to the running direction to central with respect to the running direction in discrete radius portions.

In the following, if the chain running direction, axial direction, or radial direction and corresponding terms are used without explicitly indicating otherwise, reference is made to the aforementioned spatial directions. Unless explicitly stated otherwise, ordinal numbers used in the preceding and subsequent description are used only for the purposes of clear distinction and do not indicate an order or the order of designated components. An ordinal number greater than one does not necessarily mean that another such component must be present.

The rocker pin proposed here can be used in a rocker pin pair with a further rocker pin. The two rocker pins of a rocker pin pair are in use in a plate link chain with their rolling surface in force-transmitting contact with one another and in force-transmitting contact with their link-side contact surfaces with one (other) associated plate link. For this purpose, a rocker pin has a length extension which, when in use, is parallel to the axial direction. The axial direction is defined as a direction parallel to the rotation axes of the conical pulley pairs. The plate links of a plate link chain are suspended adjacent to one another in the axial direction on the rocker pin pair or the majority of rocker pin pairs of the plate link chain and each form a plate link assembly in the case of two adjacent rocker pin pairs.

Furthermore, the rocker pin has a height extension that is parallel to the radial direction. The radial direction is defined on a wrap-around loop formed by a plate link chain, and this shape is generally oval when in use, i.e., two centers (at the rotation axes of the conical pulley pairs) are formed, which are connected by a center line. The radial direction is positively defined as extending outwards (outside the wrap-around loop) from the center line (inside the wrap-around loop). Within the wrap-around loop is referred to here as radially inside, and outside of the wrap-around loop is accordingly referred to here as radially outside.

The third spatial direction is the chain running direction, which in use depends on the location in the wrap-around loop, and thus the three spatial directions mentioned here are to be regarded as a moving coordinate system. The width extension of the rocker pin is parallel to the chain running direction. In an example embodiment, a rocker pin has an oval, approximately teardrop-shaped cross portion (with the axial direction as normal), and the rocker pin is radially narrow on the inside and radially wider on the outside. The height extension is defined as the maximum extension in the radial direction and the width extension as the maximum extension in the chain running direction (in a straight portion of the plate link chain, i.e., when used in an ideally tensioned strand).

At the end, i.e., when viewed in the axial direction, an end face is provided in each case, which is set up in force-transmitting, e.g., frictional, contact with the corresponding conical surface of the conical pulley pairs. In an example embodiment, the end face is inclined axially inward in accordance with the inclination of the conical surface of the conical pulley pairs from radially outward to radially inward, but a little more, so that the end faces of the (unloaded) rocker pin are not radially parallel to the conical surface, but only the radially outwardly arranged outer edge (minus a provided rounding radius over the outer edge to the longitudinal extension of the rocker pin, for example) comes into contact with the conical surface in the unloaded state of the rocker pin, i.e., when running into a conical pulley pair.

In an example embodiment, the end face is inclined azimuthally inwards, i.e., inclined inwards in the chain running direction from forward (with respect to the running direction) to rearward (with respect to the running direction), so that the end faces of the (unloaded) rocker pins are not azimuthally parallel to the conical surface, but only the radially outwardly arranged outer edge (minus a provided rounding radius over the outer edge to the longitudinal extension of the rocker pin, for example) comes into contact with the conical surface in the unloaded state of the rocker pin, i.e., when running into a conical pulley pair. In an example embodiment, the end faces are both axially and azimuthally inclined inward from radially outside to radially inside.

For a desired point contact or line contact, the end faces may also have a curvature. This means that the inclination of the end face is overlaid by a curvature, and a radial radius describes a curvature component based on the end face inclined axially inwards from radially outside to radially inside and an azimuthal radius describes a curvature component based on the end face inclined azimuthally (inward from forward with respect to the running direction to rearward with respect to the running direction). Providing such a curvature is well known in various variants; for example, from DE 34 47 092 A1, DE 197 08 865 A1, DE 100 03 131 A1, DE 10 2007 023 277 A1, JP 2009-209 992 A and US 9,316,287 B2.

Here, it is now proposed that the magnitude of the radial radius increases from radially outside to radially central and/or the magnitude of the azimuthal radius increases from forward with respect to the running direction to central with respect to the running direction in discrete radius portions. It has been shown that a contact point between the rocker pin and the conical surface as far radially outward as possible and/or as far forward as possible in the running direction of the chain brings acoustic advantages. Thus (as already known) a large angle difference between the conical surface and the respective end face must be set. With the end face proposed here, a contact point (or a contact line) results very far radially outside or very far forward with respect to the running direction.

At the same time, a suitable pressure distribution under load results from the radius that increases towards the center of the end face. With a higher load, i.e., a deflection (of the neutral longitudinal axis along the length extension) of the rocker pin around the chain running direction or around the radial direction, the contact point is shifted further inside in the radial direction or rearward with respect to the direction of travel, where larger radii are realized and thus the contact area is increased, so that the contact pressure is reduced at least in comparison to previously known embodiments. In an example embodiment, the radius portions are configured in such a way that there is (almost) constant pressure over the course of the load. At the same time, this ensures that the contact point remains as far as possible radially on the outside or in front of the running direction, because with the increasing radius the bending-induced displacement of the contact point is shifted less strongly radially on the inside or rearward with respect to the running direction. It is also proposed here that the radius has discrete radius portions that are assigned to a respective discrete load state range. This makes the production of the end face economical.

In one embodiment, the center of the end face is the geometric centroid. In one embodiment, it is the intersection of the neutral longitudinal axis of the rocker pin. In one embodiment, it is the contact point at a medium load, and a medium load may be a load that occurs frequently; for example, a torque transmission in an efficiency optimum of the drive engine.

It is further proposed in an example embodiment of the rocker pin that the magnitude of the radial radius decreases from radially central to radially inside and/or the magnitude of the azimuthal radius decreases from central with respect to the running direction to rearward with respect to the running direction, e.g., in discrete radius portions.

In this embodiment it is proposed that the respective radius decreases again radially inwards or rearward with respect to the direction of travel. This prevents the contact point from being displaced too far radially inward or rearward with respect to the direction of travel under heavy loads and from remaining as central as possible. This means that a small running radius can be achieved in relation to the radial radius, because the radially innermost edge of the rocker pin never comes into force-transmitting contact with the conical surface. With regard to the azimuthal radius as well as the radial radius, an edge carrier under maximum load is excluded and thus low noise emissions and low wear are achieved.

In an example embodiment, the radius has discrete radius portions that are assigned to a respective discrete load range. This makes the production of the end face economical.

According to a further aspect, a rocker pin for a rocker pin pair of a plate link chain is proposed having
a length extension which, when in use in a plate link chain, is oriented in the axial direction;
a height extension which, when in use in a plate link chain, is oriented in a radial direction;
a width extension which, when used in a plate link chain, is oriented in the chain running direction;
a plate link-side contact surface for contact with at least one link used in a plate link chain;
a rolling surface for contact with a further rocker pin used in a rocker pin pair; and
axially on both sides, an end face inclined axially inwards from radially outside to radially inside, which is aligned transversely to the longitudinal extension and is arranged for force-transmitting contact with a respective conical surface of a conical pulley pair, The end surface has a curvature, and a first curvature portion is defined by means of a radial radius about a first axis parallel to the chain running direction and a second curvature portion is defined by means of an azimuthal radius about a second axis parallel to the radial direction.

In an example embodiment, the magnitude of the radial radius increases from radially outside to radially central and/or the magnitude of the azimuthal radius increases from forward with respect to the running direction to central with respect to the running direction, and the magnitude of the radial radius decreases from radially central to radially inside and/or the magnitude of the azimuthal radius decreases from central with respect to the running direction to rearward with respect to the running direction.

The rocker pin proposed here largely corresponds to a combination of the aforementioned embodiments and reference is made to the previous description in this respect. In one possible embodiment of the rocker pin proposed herein, in contrast to the previously mentioned embodiments, the end face does not have discrete radius portions everywhere, e.g., none. Rather, magnitudes of such a radius change continuously up to the middle into larger magnitudes and from the middle back into smaller magnitudes.

It is further proposed in an example embodiment of the rocker pin that the radius portions merge tangentially into one another.

In this embodiment, a gentle transition is created between the radius portions, so that the surface pressure also remains low in a transition area. In an example embodiment, the tangential transition is continuously differentiable. A technical approach to a continuously differentiable transition in the context of cost-efficient manufacturing is economical. With a good approximation, jumps in pressure at the transitions between the radius portions are avoided. In addition to reduced noise emissions, the efficiency can be improved and the wear on the end faces of the rocker pins and the conical surfaces of the conical pulley pairs is reduced.

According to a further aspect, a rocker pin pair for a plate link chain of a belt transmission is proposed, having two rocker pins, at least one of which is designed according to an embodiment according to the aforementioned description, and the end faces of the rocker pins of the rocker pin pair may be designed identically.

The rocker pin pair proposed here includes two rocker pins, and at least one of the two rocker pins is designed according to an embodiment according to the aforementioned description, e.g., both rocker pins are designed according to an embodiment according to the aforementioned description. Since the rocker pins of a rocker pin pair are supported on one another during use due to the tensile force, they reinforce each other. Two load cases occur, i.e. initially only the front cradle thrust piece runs in, so that the rear rocker pin is initially not subject to any axial load. The bending of the front rocker pin in the direction of travel is partially absorbed, i.e., damped, by the rear rocker pin, which is unloaded in the axial direction. Subsequently, the rear rocker pin also runs into the conical pulley pair and is now also subject to the axial load of the two conical pulleys (fully run-in condition). In an example embodiment, the end faces of the rocker pins of the rocker pin pair are therefore identical, so that their deflection in the fully run-in state under the axial load is (almost) identical.

According to a further aspect, a plate link chain is proposed for a belt transmission of a drive train, having at least the following components:
a plurality of plate links; and
a corresponding number of rocker pressure piece pairs. At least one rocker pressure piece pair, e.g., exclusive rocker pressure piece pairs, are included according to an embodiment according to the aforementioned description. By means of the plate link chain, a torque is frictionally transmittable between a first conical pulley pair and a second conical pulley pair, and a transmission ratio between the conical pulley pairs may be continuously variable.

The plate link chain proposed here is set up as a traction device for a belt transmission, for example for a CVT. In a belt transmission, a plate link chain forms a wrap-around loop portion on the transmission shafts and two strands in between, one being a tight strand or load strand and the other being a slack strand. The strands and the wrap-around loop portions together form an (oval) wrap-around loop, as explained above. A wrap-around loop does not mean a loop with a constant radius, but a circumferentially closed structure. The form is defined by the running radii (set by means of a pulley distance) of the conical pulley pairs of the belt transmission. The spatial directions are also defined here as explained above.

The plate link chain has a chain width, and across this chain width a plurality of plate links are usually arranged adjacent to one another and form a plate link assembly. In use, the chain width is oriented parallel to the orientation of the at least two transmission shafts. The chain width is defined by the width extension of the rocker pins, and the (axial) ends of the rocker pins protrude beyond the plate link assembly so that the plate links do not come into frictional contact with the corresponding surface of the pulley pairs.

The plate link chain has a large number of plate links, and a plurality of plate link types (as explained above) for reduced noise emission, for example two plate link types, namely a short plate link and a long plate link. The plate links (of a plate link assembly) each have two adjacent rocker pin pairs. A rocker pin pair has a fixed rocker pin and a free rocker pin in relation to a plate link. Two plate links are each connected to one another in a traction-transmitting manner by means of a common rocker pin pair, and the designation as a free or fixed rocker pin is reversed in each case for the other plate link. The two rocker pins of a rocker pin pair are in direct contact with one another in a force-transmitting manner as a result of the traction force transmitted during the operation of the belt transmission by the plate links of the plate link chain and thus the plate link load acting on the rocker pin pair (applying on both sides in the chain running direction). The two rocker pins of the rocker pin pair thus transfer the traction force of the plate links to one another as a pressure force and, during motion in a belt transmission, roll off one another by means of their rolling surfaces lying against one another in a force-transmitting manner. The rolling surfaces are curved or kinked and thus describe a rocking motion on one another during operation of the belt transmission.

In a CVT, for example, the end faces of the rocker pins are designed to be inclined radially outwardly to radially inwardly on the inside in order to create an approximately parallel contact surface with the (inclined conical) surfaces of the conical pulley pairs, or (as explained above) for reduced noise emission with a greater inclination of the end faces than the conical surfaces of the conical pulley pairs.

In a CVT, a torque is introduced into the plate link chain via the end faces of the rocker pins. The rocker pins are thus loaded on both sides with an axial pressing force. The plate links transmit the torque as a tensile load to the respective associated rocker pins; for example, the immediately adjacent rocker pin, at least on the currently free, i.e., not axially pressed, rocker pins (at least of the load strand). The rocker pins or rocker pin pairs are thus linked by means of the multiplicity of plate links in a manner that transmits tensile force.

In an example embodiment, the plate link chain is set up as a looping means for a continuously variable transmission and the end faces of the rocker pins of the plate link chain are frictionally engaged in force-transmitting contact with the corresponding (conical) surfaces of the conical pulley pairs.

Here it is now proposed that in the end faces of the rocker pins of the rocker pin pairs of the plate link chain the magnitude of the radial radius increases from radially outside to radially central and/or the magnitude of the azimuthal radius increases from forward with respect to the running direction to central with respect to the running direction, e.g., in discrete radius portions, and the magnitude of the radial radius decreases from radially central to radially inside and/or the magnitude of the azimuthal radius decreases from central with respect to the running direction to rearward with respect to the running direction, for example, in discrete radius portions. With low noise emissions across the load cases (e.g. depending on the gear ratio states and/or the applied torque gradient), such a plate link chain has (almost) constant pressure on the end faces and thus an exact design limit for a maximum load on the conical surfaces of the conical pulley pairs, based on which a desired wear property or service life of the plate link chain and the belt transmission can be designed. The plate link chain proposed here can be used without additional measures to replace a conventional plate link chain.

According to a further aspect, a belt transmission is proposed for a drive train, having at least the following components:
a first conical pulley pair with a first rotation axis and with a variable axial first pulley distance;
a second conical pulley pair with a second rotation axis with a variable axial second pulley distance; and
a plate link chain according to an embodiment according to the aforementioned description. The two conical pulley pairs are arranged by means of the plate link chain, which is arranged as a traction means axially pressed into the conical pulley pairs, with a transmission ratio, which is dependent on the set pulley distances, and which are connected to one another in a torque-transmitting manner, and the transmission ratio between the conical pulley pairs may be continuously variable.

The belt transmission is set up for a drive train, for example a motor vehicle, and includes at least a first conical pulley pair arranged on a first transmission shaft, for example the transmission input shaft, and a second conical pulley pair arranged on a second transmission shaft, for example the transmission output shaft, as well as one for torque transmission between the conical pulley pairs provided loop means, namely the plate link chain described above. A conical pulley pair has two conical pulleys which are oriented with corresponding conical surfaces to each other and are axially movable relative to each other. In an example embodiment, the (first) conical pulley, also referred to as a loose pulley or movable pulley, can be displaced (axially displaced) along its rotation axis and the (second) conical pulley, also referred to as a fixed pulley, is fixed (axially fixed) in the direction of the rotation axis. In this way, the respective pulley distance of the conical pulley pair in question can be changed.

When the belt transmission is in operation, the plate link chain is displaced as a result of the conical surfaces of the two conical pulleys by means of a relative axial movement of the conical pulley of a conical pulley pair between an inner position (small or minimum running radius) and an outer position (large or maximum running radius) in a radial direction (relative to the respective rotation axis). The plate link chain thus runs on a changeable running radius. As a result, a different rotational speed transmission ratio and torque transmission ratio can be, e.g., continuously, adjusted from one conical pulley pair to the other conical pulley pair.

The belt transmission proposed here has a plate link chain according to the above description, and the rocker pins of the plate link chain, due to the curvature of the end faces according to the above description, with a low noise emission over the load cases, has (almost) constant pressure on the end faces and thus an exact design limit for a maximum load of the conical surfaces of the conical pulley pairs, on the basis of which a desired wear property or service life of the plate link chain and the belt transmission can be designed. The belt transmission proposed here can be used without additional measures to replace a conventional belt transmission.

According to a further aspect, a drive train is proposed, having at least the following components:
at least one drive engine;
at least one consumer; and
a belt transmission according to an embodiment according to the aforementioned description, The at least one drive engine for torque transmission by means of the belt transmission is connected to the at least one consumer with a variable transmission.

The drive train, for example, of a motor vehicle used to drive at least one drive wheel (consumer), is designed to transmit a torque provided by one or a plurality of drive engines, for example an internal combustion engine and/or an electric drive engine, and output via the respective machine shaft thereof, i.e., the combustion drive shaft and/or the rotor shaft, for example, for use by a consumer as required, i.e., taking into account the required speed and the required torque. One use is, for example, an electrical generator to provide electrical energy and/or the transmission of torque to a drive wheel of a motor vehicle to propel the same.

In order to transmit the torque in a targeted manner and/or by means of a manual transmission with different gear ratios, the use of the belt transmission described above is helpful as the plate link chain enables a high level of efficiency in terms of torque transmission. The plate link chain proposed here also has a long service life with a high transmissible torque while at the same time emitting low noise.

### BRIEF DESCRIPTION OF THE DRAWINGS

The disclosure described above is explained in detail below based on the relevant technical background with reference to the associated drawings, which show example embodiments. The disclosure is in no way restricted by the purely schematic drawings, wherein it should be noted that the drawings are not dimensionally accurate and are not suitable for defining proportions. In the figures;

FIG. 1 shows a front view of a rocker pin;

FIG. 2 shows a top view of a rocker pin;

FIG. 3 shows a side view of a rocker pin;

FIG. 4 shows a radius course in a first embodiment;

FIG. 5 shows a radius course in a second embodiment; and

FIG. 6 shows a drive train with a belt transmission.

### DETAILED DESCRIPTION

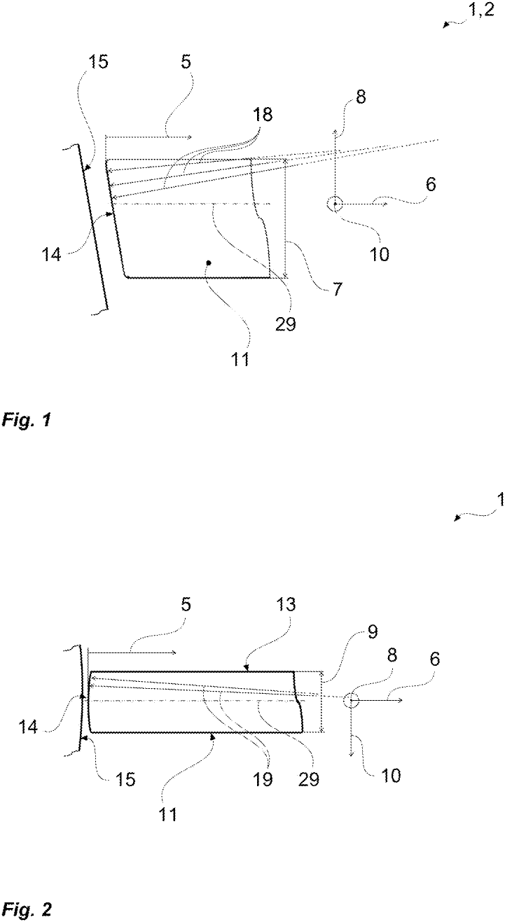

FIG. 1 shows a portion of a front or rear rocker pin 1, 2 in a front view, so that we can see the contact surface 11 on the side of the plate link, for example. According to the illustration, the radial direction 8 runs from bottom to top, the chain running direction 10 runs out of the plane of the drawing and the axial direction 6 runs from left to right. The longitudinal extension 5 of the rocker pin 1, 2 is aligned here in the axial direction 6 and the height extension 7 in the radial direction 8. The conical surface 15 is indicated on the left in the illustration (for clarity at a distance from the end face 14), with which the end face 14 forms a line contact (extending in the chain running direction 10) or point contact due to the radial radius 18.

The radial radius 18 (drawn in an exemplary manner) of various (e.g., directly adjacent) radial portions 20 are executed with a variable magnitude and the magnitude increases in comparison of the radial radius 18 of the end face 14 with each other from radially outside to radially central, and the radial portions 20 may run discretely. The radial radius 18 are defined pivoted about a parallel (first axis) to the chain running direction 10. The center of the end face 14 is, for example, the exit point of the neutral axis 29. The curvature of the end face 14 is so small that it is not visible in this view. An ideal tangential or (as close as technically possible or as far as economically viable) an approximation to an ideal tangential transition between the radius portions 20 is therefore not necessary in every case.

FIG. 2 shows a portion of a front rocker pin 1 according to FIG. 1 in a plan view, so that the contact surface 11 on the plate link side can be seen at the bottom and the rolling surface 13 can be seen at the top, according to the illustration. Here, the chain running direction 10 runs (corresponding to the contact surface 11 on the plate link and the rolling surface 13) according to the illustration from top to bottom, the radial direction 8 runs out of the image plane and the axial direction 6 runs from left to right. In the case of a rear rocker pin 2, the contact surface 11 on the plate link side and the rolling surface 13 would be interchanged. In this illustration, the width extension 9 of the front rocker pin 1 is shown in a comprehensible manner, which is aligned parallel to the chain running direction 10. The diffraction of the end face 14 and the conical surface 15 is exaggerated here for clarity.

Two azimuthal radii 19 are shown pivoting about a parallel (second axis) to the radial direction 8. The magnitude of the azimuthal radius 19 is variable and increases from forward with respect to the running direction to central with respect to the running direction, wherein the radius portions 20 are discrete, for example. The center of the end face 14 is, for example, the exit point of the neutral axis 29. The curvature of the end face 14 is very small. An ideal tangential or (as close as technically possible or as far as economically viable) an approximation to an ideal tangential transition between the radius portions 20 is therefore not necessary in every case.

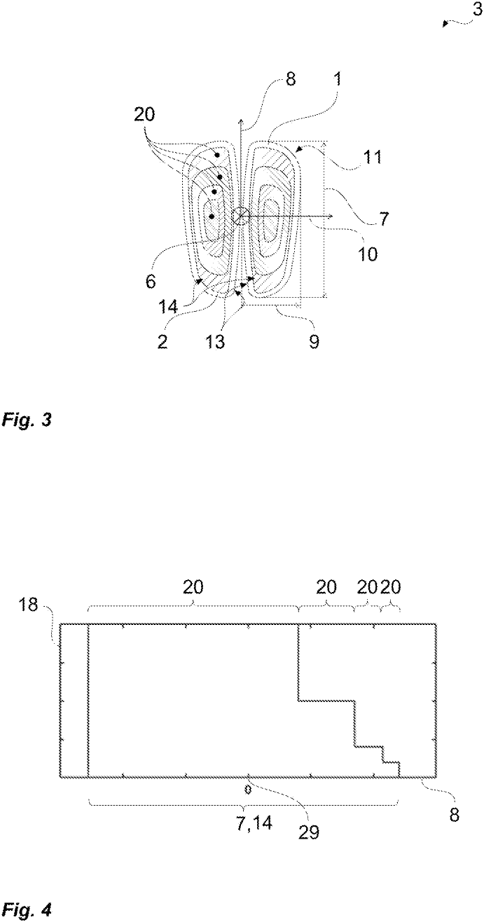

FIG. 3 shows a side view of a rocker pin pair 3 with a front rocker pin 1 (here shown on the right) and a rear rocker pin 2, so that the view is directed towards one of the two end faces 14 in each case. For the sake of clarity, the features of the rocker pins 1, 2 are not designated twice for the rocker pins 1, 2 everywhere. In this embodiment, the properties apply to both rocker pins 1, 2, wherein here (optionally) the end faces 14 of the two rocker pins 1, 2 are formed mirror-identically, e.g., both rocker pins 1, 2 are completely identical. Then both end faces 14 of a rocker pin 1, 2 are identical. In an example embodiment, the description of the front rocker pin 1 applies to the rear rocker pin 2 and vice versa. According to the illustration, the radial direction 8 runs from bottom to top, the chain running direction 10 runs from left to right and the axial direction 6 runs into the image plane. The dimensions of the rocker pin 1 are defined as the height extension 7 (in the radial direction 8), the width extension 9 (in the chain running direction 10) and the length extension 5 (in the axial direction 6, see FIGS. 1 and 2).

The end face 14 is designed for force-transmitting, e.g., exclusively frictional, contact with the conical surfaces 15 (see FIGS. 1 and 2) of the conical pulleys of the conical pulley pairs 16, 17. The rocker pins 1, 2 each have a rolling surface 13 which forms a force-transmitting contact with the other rocker pin 2, 1 when in use in a plate link chain 4 (see FIG. 6) in the rocker pin pair 3. The rocker pin 1, 2 has a plate link-side contact surface 11 opposite the respective rolling surface 13 in the chain running direction 10, which has an arcuate shape and is in direct force-transmitting contact with a plurality of links 12 (ref. FIG. 6) when used in a plate link chain 4 (ref. FIG. 6). The tensile force in the tightening side of the plate link chain 4 is transmitted via the rocker pin pair 3 as a compressive force to the respective further link plates 12, and the rolling surfaces 13 of the rocker pins 1, 2 roll on one another weighing on one another when the plate link chain 4 bends, for example on a conical pulley pair 16, 17.

The rocker pins 1, 2 each have, on the end face 14, at least two, here four, discrete radius portions 20 (shown with contour lines), which each have a magnitude-constant radial radius 18 and a constant azimuthal radius 19. The magnitude of the radial radius 18 increases from radially outside to radially central and decreases from radially central to radially inside. The magnitude of the azimuthal radius 19 also decreases from forward with respect to the running direction to central with respect to the running direction and from central with respect to the running direction to rearward with respect to the running direction.

In FIG. 4 a radius course in a first embodiment is shown in a graph, wherein the y-axis represents the radial radius 18 and the x-axis represents the radial position on the end face 14. For example, the y-axis does not start at zero. Zero in the x-axis is the center of the vertical extension 7 of the end face 14; for example, the (radial) position of the neutral axis 29 (see FIG. 1). The end of the vertical extension 7 to the left of zero on the x-axis is therefore radially inside and the end of the height extension 7 to the right of zero is radially outside. The magnitude of the radial radius 18 thus increases from radially outside to radially central and then remains constant until radially inside. The changes in the magnitudes of the radial radius 18 in the radius portions 20 are discrete, i.e., (discontinuously) erratic. Alternatively, a transition is continuous, i.e., a (slightly) inclined transition flank and a rounded transition are formed in the flank. This first embodiment of the radius course is configured, for example, for a small number of gear ratio states or load cases. This is optimal if these load cases occur particularly frequently and/or last a particularly long time compared to other load cases.

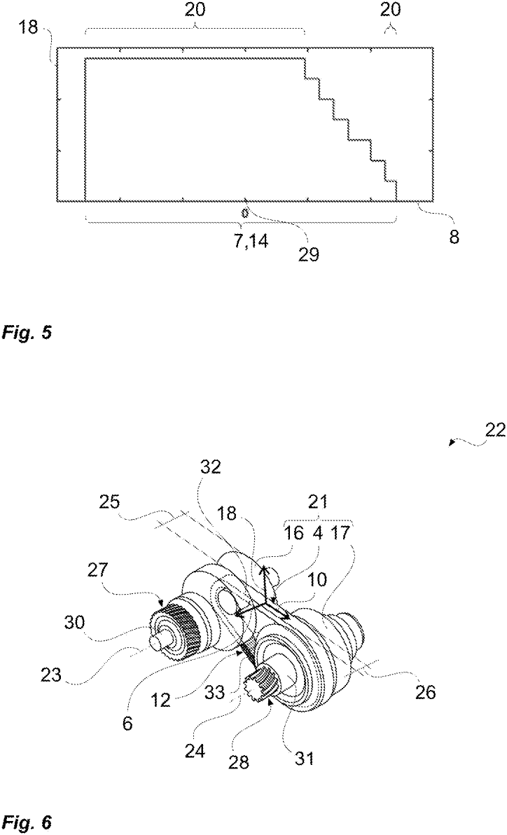

In FIG. 5, a radius course in a second embodiment is shown in a graph, wherein the y-axis and the x-axis are defined as in FIG. 4. The magnitude of the radial radius 18 thus in turn increases from radially outside to radially central and then remains constant until radially inside. The change in the magnitudes of the radial radius 18 in the radius portions 20 (here, purely for the sake of clarity, only those at the ends are referred to) are discrete. In contrast to the first embodiment according to FIG. 4, the radial radius 18 is faster in the radially outside region and/or formed in smaller increments. While the first embodiment according to FIG. 4 is configured for a few load cases, the embodiment shown here has a finer subdivision and is therefore more optimally designed for many different load cases that occur with approximately the same frequency and/or the same duration.

FIG. 6 shows a perspective view in a portion of a drive train 22 with a belt transmission 21. in which a plate link chain 4 acting as a traction mechanism runs on two conical pulley pairs 16, 17. The plate link chain 4 has a chain width in the axial direction 6 (parallel to the rotation axes 23, 24) which corresponds to the length extension 5 of the rocker pin pairs 3. A defined pulley distance 25, 26 thus leads to a resulting active loop on the respective conical pulley pair 16, 17. In this case, the first pulley distance 25 is large and therefore the first active loop is small, and the second pulley distance 26 is small and the second active loop is therefore large. A torque ratio greater than 1, for example 2, is thus implemented by means of the belt transmission 21 from a first transmission shaft 30, for example a transmission input shaft, with a first rotation axis 23, to a second transmission shaft 31, for example a transmission output shaft, with a second rotation axis 24.

At least two plate links 12 are linked together to form a ring by means of the large number of rocker pin pairs 3 (for the transmission of traction force in the strands 32, 33). Generally, a plurality of plate links 12 is arranged next to one another in the axial direction 6. A coordinate system is shown here in the first strand 32, which corresponds to the coordinate system according to the previous figures. The chain running direction 10 lies in the plane of the plate link chain 4 ring. The axial direction 6 (corresponding to the direction of the chain width) is oriented parallel to the rotation axes 23, 24. The radial direction 8 points outwards from the ring formed by the plate link chain 4. The position of the coordinate system shown is defined in any point of the plate link chain 4 and the orientation of the chain running direction 10 and the radial direction 8 as well as the position of the axial direction 6 change with the movement of the plate link chain 4.

For example, a drive engine 27 is connected to the first transmission shaft 30, wherein only the torque-receiving input gear is shown here. For example, a consumer 28, for example at least one drive wheel for a motor vehicle, is connected to the second transmission shaft 31, wherein only the torque-emitting output gear is shown here.

Here, a further reduction in noise emissions and an increase in service life are achieved by means of the proposed rocker pin.

### REFERENCE NUMERALS

1 Front rocker pin
2 Rear rocker pin
3 Rocker pin pair
4 Plate link chain
5 Length extension
6 Axial direction
7 Height extension
8 Radial direction
9 Width extension
10 Chain running direction
11 Plate-side bearing face
12 Plate link
13 Rolling surface
14 End face
15 Conical surface
16 First conical pulley pair
17 Second conical pulley pair
18 Radial radius
19 Azimuthal radius
20 Radius portions
21 Belt transmission
22 Drive train
23 First rotation axis
24 Second rotation axis
25 First pulley distance
26 Second pulley distance
27 Drive engine
28 Consumer
29 Neutral fiber
30 First transmission shaft
31 Second transmission shaft
32 First strand
33 Second strand

1. A rocker pin for a rocker pin pair of a plate link chain, comprising:
a length extension which, when in use in the plate link chain, is oriented in an axial direction;
a height extension which, when in use in the plate link chain, is oriented in a radial direction;
a width extension which, when used in the plate link chain, is oriented in a chain running direction;
a plate link-side contact surface for contact with at least one link used in the plate link chain;
a rolling surface for contact with a further rocker pin used in the rocker pin pair; and
axially on both sides, an end face inclined axially inwards from radially outside to radially inside, which is aligned transversely to the length extension and arranged for force-transmitting contact with a respective conical surfaced of a conical pulley pair,
wherein the end face has a curvature,
wherein a first curvature portion is defined by means of a radial radius about a first axis parallel to the chain running direction and a second curvature portion is defined by means of an azimuthal radius about a second axis parallel to the radial direction,
wherein a magnitude of the radial radius increases from radially outside to radially central or a magnitude of the azimuthal radius increases from forward with respect to the chain running direction to central with respect to the chain running direction in discrete radius portions.

2. The rocker pin of claim 1, wherein the magnitude of the radial radius decreases from radially central to radially inside or the magnitude of the azimuthal radius decreases from central with respect to the running direction to rearward with respect to the running direction.

3. A rocker pin for a rocker pin pair of a plate link chain, comprising:
a length extension which, when in use in the plate link chain, is oriented in an axial direction;
a height extension which, when in use in the plate link chain, is oriented in a radial direction;
a width extension which, when used in the plate link chain, is oriented in the chain running direction;
a plate link-side contact surface for contact with at least one link used in the plate link chain;
a rolling surface for contact with a further rocker pin used in the rocker pin pair; and
axially on both sides, an end face inclined axially inwards from radially outside to radially inside, which is aligned transversely to the length extension and is arranged for force-transmitting contact with a respective conical surface of a conical pulley pair,
wherein the end surface has a curvature,
wherein a first curvature portion is defined by means of a radial radius about a first axis parallel to the chain running direction and a second curvature portion is defined by means of an azimuthal radius about a second axis parallel to the radial direction ,
wherein a magnitude of the radial radius increases from radially outside to radially central or the a magnitude of the azimuthal radius increases from forward with respect to the chain running direction to central with respect to the chain running direction, and
the magnitude of the radial radius decreases from radially central to radially inside or the magnitude of the azimuthal radius decreases from central with respect to the chain running direction to rearward with respect to the chain running direction.

4. The rocker pin of claim 3, wherein
radius portions of the first curvature portion and the second curvature portion merge tangentially into one another.

5. A rocker pin pair for a plate link chain of a belt transmission, having
two rocker pins, at least one of which is designed according to claim 3,
wherein the end faces of the rocker pins of the rocker pin pair are designed identically.

6. A plate link chain for a belt transmission of a drive train, comprising:
a plurality of plate links; and
a corresponding number of rocker pin pairs according to claim 5,
wherein by means of the plate link chain, a torque is frictionally transmittable between a first conical pulley pair and a second conical pulley pair,
wherein a transmission ratio between the conical pulley pairs is preferably continuously variable.

7. A belt transmission for a drive train, comprising:
a first conical pulley pair with a first rotation axis and with a variable axial first pulley distance;
a second conical pulley pair with a second rotation axis with a variable axial second pulley distance; and
the plate link chain of claim 6,
wherein the first and second conical pulley pairs are arranged by means of the plate link chain, which is arranged as a traction means axially pressed into the conical pulley pairs, with a transmission ratio, which is dependent on set pulley distances, and which are connected to one another in a torque-transmitting manner, and
wherein the transmission ratio between the conical pulley pairs is continuously variable.

8. A drive train, comprising:
at least one drive engine;
at least one consumer; and
the belt transmission of claim 7,
wherein the at least one drive engine is connected to the at least one consumer for torque transmission by means of the belt transmission with a variable transmission.

9. A plate link chain comprising:
a chain running direction;
an axial direction normal to the chain running direction;
a radial direction normal to the chain running direction and normal to the axial direction;
a plate link; and
a rocker pin pair, each rocker pin of the rocker pin pair comprising:
a plate link side contact surface arranged to contact the plate link:
a rolling surface arranged for contact with the other rocker pin of the rocker pin pair; and
axially opposite end faces:
inclined axially inwards from radially outside to radially inside;
aligned transversely to the axial direction;
arranged for force transmitting contact with respective contact surfaces of a conical pulley pair; and
comprising respective curvatures having:
a first curvature portion defined by a radial radius about a first axis parallel to the chain running direction; and
a second curvature portion defined by an azimuthal radius about a second axis parallel to the radial direction, wherein:
a magnitude of the radial radius increases from radially outside to radially central in discrete radius portions; or
a magnitude of the azimuthal radius increases from forward to central with respect to the chain running direction in discrete radius portions.

10. The plate link chain of claim 9, wherein:
the magnitude of the radial radius decreases from radially central to radially inside in discrete radius portions; or
the magnitude of the azimuthal radius decreases from central to rearward with respect to the chain running direction in discrete radius portions.

11. The plate link chain of claim 10 wherein the discrete radius portions merge tangentially into one another.

12. The plate link chain of claim 9 wherein the axially opposite end faces are designed identically.

13. The plate link chain of claim 9 further comprising:
a plurality of the plate links; and
a plurality of the rocker pin pairs connecting the plurality of the plate links.

14. A belt transmission for a drive train comprising:
a first conical pulley pair;
a second conical pulley pair; and
the plate link chain of claim 13 arranged as a traction means axially pressed into the first conical pulley pair and the second conical pulley pair.

15. The belt transmission of claim 14 wherein respective pulley distances between the first conical pulley pair and the second conical pulley pair are both continuously variable.

16. A drive train comprising:
a drive engine;
a consumer; and
the belt transmission of claim 15 connecting the drive engine to the consumer for torque transmission therebetween.
